(19) United States
(12) Patent Application Publication
(10) Pub. No.: US 2014/0103783 A1
(43) Pub. Date: Apr. 17, 2014

(54) DRIVE SYSTEM HAVING A BEARING TILT DETECTION SYSTEM, AND ELECTRIC OR HYBRID VEHICLE HAVING THE SAME

(71) Applicants: Tobias Vogler, Herzogenaurach (DE); Raphael Fischer, Herzogenaurach (DE); Mark Lauger, Grossweinstein (DE); Jan Ortner, Nurenberg (DE)

(72) Inventors: Tobias Vogler, Herzogenaurach (DE); Raphael Fischer, Herzogenaurach (DE); Mark Lauger, Grossweinstein (DE); Jan Ortner, Nurenberg (DE)

(73) Assignee: Schaeffler Technologies AG & Co., KG, Herzogenaurach (DE)

(21) Appl. No.: 14/125,861

(22) PCT Filed: Apr. 11, 2012
(86) PCT No.: PCT/EP2012/056484

§ 371 Date: Dec. 12, 2013

(30) Foreign Application Priority Data
Jul. 7, 2011 (DE) DE102011078807.7

(51) Int. Cl. H02K 11/00; H02K 7/102

(52) U.S. Cl. CPC H02K 11/001; H02K 7/102
USPC 310/68 B

(57) ABSTRACT

A drive system, in particular for an electric and/or hybrid vehicle, including a static part (S) and a rotatably mounted part (D) and also an electric motor with a stator (1) and rotor (2), wherein the static part (S) includes the stator (1) and the rotatably mounted part (D) includes the rotor (2). To identify a tilt of the bearing or of the rotor, in particular in order to prevent abrasion of the rotor (2) against the stator (1) and/or to identify damage in the system, the drive system includes a bearing tilt detection system for detecting a bearing tilt of the rotatably mounted part (D), wherein the bearing tilt detection system evaluates data of the electric motor and/or of at least one sensor (10, 20, 30) with regard to whether a bearing tilt is present. The invention also relates to an electric and/or hybrid vehicle.

The present invention relates to a drive system and to an electric and/or hybrid vehicle.

### BACKGROUND

In recent years, the interest in electric vehicles has increased more and more in particular as a result of growing environmental consciousness.

In electric automobiles, inter alia, electric wheel hub drives may also be used in addition to central electric motors and electric motors close to the wheel. Electric wheel hub drives are a special specific embodiment of an electric motor and include an electric motor which is installed directly in a wheel of a vehicle and bears the wheel hub at the same time, so that a part of the motor revolves with the wheel.

In electric motors, in particular in electric motors designed as a wheel hub drive, the running precision of the motor rotor represents an important requirement. To achieve the highest possible force density or torque density, the air gap between stator and rotor is designed to be as small as possible. External effects, for example, lateral forces when negotiating curves, may result in tilting of the rotor bearing or wheel bearing and therefore also of the rotor, however, in particular in electric motors designed as wheel hub drives. Tilting of the rotor may result in a magnetic force imbalance in the air gap, which further assists bearing tilting.

A bearing system for mounting at least one machine part, which has at least one first and one second piezoelement, is known from DE 102004024851 A1. Inter alia, tilting of at least one machine part may be detected using these piezoelements.

A system for recognizing a displacement of a rotor of a dynamoelectric machine from its equilibrium position is known from US 2011/0031836 A1. The mentioned displacement may be detected using an electromagnetic or magnetic sensor, in particular an inductive sensor, a capacitive sensor, or an eddy current sensor. Furthermore, optical and/or acoustic sensors come into consideration for measuring the displacement.

### SUMMARY OF THE INVENTION

It is an object of the present invention to provide recognizing a tilting of the bearing or of the rotor, in particular to prevent grinding of the rotor on the stator and/or to recognize damage in the system.

The present invention provides a drive system, in particular for an electric and/or hybrid vehicle, including a stationary part and a rotatably mounted part, an electric motor having a stator and a rotor, the stationary part including the stator and the rotatably mounted part including the rotor, and a bearing tilt detection system for detecting a bearing tilt of the rotatably mounted part, characterized in that the bearing tilt detection system analyzes data of the electric motor and/or at least one sensor as to whether a bearing tilt exists, the electric motor being designed as a wheel hub drive. The bearing between the stationary part and the rotatable part may be a wheel bearing in particular. The drive system is suitable in particular for a vehicle, for example, for an electric and/or hybrid vehicle.

A bearing tilt may advantageously be recognized and counteracted by the bearing tilt detection system. On the one hand, derating or targeted activation of the drive systems (torque vectoring) may be initiated, to reduce the forces acting on the bearing and therefore also the tilt. For example, as an expansion of an ESP (electronic stability control) system, for example, the wheel speed and/or the braking torque and/or the drive torque of one or multiple vehicle wheels may be reduced in a targeted manner and, in particular in the case of wheel hub drives, in contrast to conventional ESP systems, even intentionally increased, to reduce forces acting on the bearing and the tilt. Furthermore, a warning message may be output to the vehicle driver, to suggest to him an adaptation of the mode of driving and/or the performance of maintenance work. If this message is disregarded, an emergency running mode of the drive system may even be initiated, in which the performance capability of the vehicle is restricted by control technology. Overall, damage to the drive system, in particular the rotor and stator, may thus be avoided.

Alternatively or additionally thereto, internal documentation of the bearing load or bearing tilt may be carried out. Thus, conclusions about the utilization of the vehicle, possibly a misuse of the vehicle and/or the state of the system, in particular the bearing, may thus advantageously be drawn. For example, if the analysis of already existing sensors shows that the load of the bearing may not be high and the bearing or the rotatably mounted part of the system nonetheless tilts strongly, this may be an indication of bearing damage or damage in the system, and it may be suggested to the vehicle driver that maintenance work is to be carried out, for example.

The electric motor may be an internal-rotor motor or an external-rotor motor. The electric motor may have a rotor support for fastening the rotor on a bearing, in particular on the rotatable part of a wheel bearing, for example, on a rotatable outer ring or inner ring of a wheel bearing. The electric motor is preferably operable as a motor and generator.

Within the scope of one specific embodiment, the stator has stator windings used as electromagnets. The bearing tilt detection system for detecting a bearing tilt may analyze data about the inductance, in particular of the stator windings. This is based on the fact that in particular the magnetic resistance between the two bodies may change due to a tilt of the rotor in relation to the stator. In particular, a tilt may result in an increase of the inductance of the stator windings, above all perpendicularly to the tilt axis. The degree of the tilt may thus be established via a measurement of the inductance, in particular of the stator windings. This procedure may be advantageous in particular at low speeds. The measurement of the inductance, in particular of the individual stator windings, may be carried out directly or indirectly for this purpose. Sensor-free methods for establishing the electrical rotor angle, for example, INFORM, voltage/current space vector modulation, are also based on a direct or indirect measurement of the inductance of the individual stator windings. Such methods may therefore advantageously be used—optionally with some modifications—for the detection of a bearing tilt. Thus, a multifunctionality may advantageously be achieved without the use of additional systems. In addition, the amount, in particular the degree, of a bearing tilt may advantageously be determined in this way and a quantifiable statement may be made about the tilt of the bearing or the components connected to the bearing, in particular the rotor.

Within the scope of another specific embodiment, the bearing tilt detection system for detecting a bearing tilt analyzes data about the induced counter voltage ((counter EMF) during motor operation), in particular in the stator windings and/or the induced voltage ((EMF) during generator (idle) operation), in particular in the stator windings. This procedure may be advantageous in particular at high speeds. Since a reduction of the magnetic resistance between rotor and stator—at uniform magnetic field strength of the rotor—may result in particular in a higher magnetic flux through the stator windings, the induced counter voltage, which is determined by the chronological change of the flux through the observed stator winding, may also increase. Therefore, sensor-free, EMF-based methods, which are presently used to measure the rotor speed, may be used—if necessary with some modifications—for the detection of a bearing tilt. Thus, a multifunctionality may advantageously be achieved without the use of additional systems. In addition, the amount, in particular the degree, of a bearing tilt may advantageously be determined in this way and a quantifiable statement may be made about the tilt of the bearing or the components connected to the bearing, in particular the rotor. The bearing tilt detection may be carried out over the entire speed range by a combination of the two above-mentioned specific embodiments.

Since these are in particular analog measured variables, whose precision is essentially dependent on production tolerances and the measurement technology used, the time curve of the tilt may also be determined, which permits conclusions to be drawn about the load of the various components, such as bearings or shafts, and/or their wear.

Instead of the sensor-free method, a resolver, in particular a circuit board resolver, may also be used for detecting a bearing tilt.

Within the scope of another specific embodiment, the bearing tilt detection system for detecting a bearing tilt analyzes data from a resolver. In this way, the amount, in particular the degree, of a bearing tilt may also advantageously be determined and a quantifiable statement may be made about the tilt of the bearing or the components connected to the bearing, in particular the rotor.

Within the scope of another specific embodiment, the rotatably mounted part of the drive system has an encoder ring having a permanent magnet and the stationary part of the drive system has at least one sensor, which is oriented toward the encoder ring, for measuring the magnetic flux density. The at least one sensor may read out the magnetic field of the encoder ring—similarly to ABS sensing. The bearing tilt detection system for detecting a bearing tilt may analyze in particular data of the at least one sensor for measuring the magnetic flux density.

In particular, the stationary part of the drive system may have at least two sensors, which are oriented toward the encoder ring, for measuring the magnetic flux density, the bearing tilt detection system for detecting a bearing tilt analyzing data of the sensors for measuring the magnetic flux density.

Within the scope of one embodiment, at least one of the sensors for measuring the magnetic flux density is situated above or below the bearing, in particular in a position in relation to the bearing in a range between an 11 o'clock position and a 1 o'clock position and/or between a 5 o'clock position and a 7 o'clock position, and/or at least one of the sensors is situated at least essentially in the plane of the bearing, in particular in a position in relation to the bearing in a range between an 8 o'clock position and a 10 o'clock position and/or between a 2 o'clock position and a 4 o'clock position.

The sensors for measuring the magnetic flux density may be both active sensors and passive sensors. For example, magnetoresistive sensors, inductive sensors, and/or Hall sensors may be used in particular as sensors for measuring the magnetic flux density.

In addition to the methods which optionally utilize existing sensors, a distance measurement, in particular a direct distance measurement, may also be carried out by one or multiple additionally incorporated suitable sensors.

Within the scope of another specific embodiment, the bearing tilt detection system for detecting a bearing tilt therefore analyzes data of at least one distance sensor. The distance sensor(s) is/are advantageously positioned as far as possible from the running axis, since axis-remote components are deflected by a greater distance in the event of a bearing tilt than axis-proximal components and thus a more precise determination of the amount, in particular the degree, of a bearing tilt may be carried out.

Within the scope of another specific embodiment, the bearing tilt detection system for detecting a bearing tilt analyzes data from a stop sensor. The stop sensor has in particular an electrical contact element, which is situated on the stationary part of the drive system, spaced apart from the rotatably mounted part of the drive system. The stop sensor is situated in particular in such a way that it may be contacted by the part of the rotatably mounted drive system if a predetermined amount of a bearing tilt is exceeded. If a predetermined amount of a bearing tilt is exceeded, in particular an electric contact, in particular a circuit, between the electrical contact element and the rotatably mounted part of the drive system may be closed and an electrical signal may be output, for example.

Within the scope of another specific embodiment, a contact of the stop sensor and the rotatable part of the drive system and/or an electrical contact between the electrical contact element and the rotatable part of the drive system occurs in the case of a smaller amount of the bearing tilt than a contact of the stator and rotor. In this way, in particular the above-explained countermeasures may be taken in a timely fashion and damage to the rotor and/or stator may be avoided.

Within the scope of another specific embodiment, the stop sensor has a stop element. The stop element may be designed in particular for the purpose of transmitting the force flow between the rotating components and the stationary components in the event of a collision or a touch of the rotating part and therefore to protect the rotor from a collision with the stator and/or to protect the bearing from an overload. The stop element and the stop sensor may therefore also be designated as a touch element or a touch sensor, respectively. To avoid grinding noises, it is advantageous to implement the stop element from an acoustically neutral material. Inter alia, brass, for example, is suitable as a material for the stop element.

Within the scope of one embodiment, the amount of a bearing tilt, which results in a contact between the stop sensor and the rotatably mounted part of the drive system, is the same as that which results in closing of an electrical contact or circuit between the electrical contact element and the rotatably mounted part of the drive system, since in this embodiment the rotatably mounted part directly contacts the electrical contact element and closes the electrical contact upon exceeding the predetermined bearing tilt amount. In particular, the stop element may be used as an electrical contact element.

The stop element may be positioned in particular in such a way that in the event of a strong bearing or rotor tilt, it detects the movement of one of the tilting components in such a way that it closes a circuit by axial or radial contact. A simple 1/0 detection of a stop may be carried out in this way.

Depending on the requirement, the stop sensor may also have a recessed electrical contact element, which may only be electrically contacted after a certain degree of wear. For example, the electrical contact element may be implemented in a borehole within the stop element, which is provided with an electrical insulation layer, so that an electrical contact or circuit is only closable after wear of the stop element and the insulation layer. In particular, the stop sensor may include an insulation element for the electrical insulation of the electrical contact element from the stop element. Within the scope of this embodiment, the amount of a bearing tilt which results in a contact between the stop sensor and the rotatably mounted part of the drive system is generally not equal to that which results in closing of an electrical contact or circuit between the electrical contact element and the rotatably mounted part of the drive system, since an electrical contact between the electrical contact element and the rotatably mounted part of the drive system may only be closed after at least partial abrasive wear of the stop element and the insulation element by one or multiple contacts with the rotatably mounted part of the drive system. This information may additionally be used to output a warning message, for example, with the aid of a warning light, to the vehicle driver, to initiate a replacement of the stop element.

Within the scope of another specific embodiment, the stop sensor is situated axially or radially, in particular axially, with respect to the rotatably mounted part of the drive system.

Within the scope of another specific embodiment, the stop sensor is situated remotely from the bearing and/or adjacent to a component of the rotatably mounted part of the drive system which has a large diameter.

Situating the stop sensor on a large diameter in such a way that it represents an axial stop is particularly advantageous, since an axial movement of the touching parts is described by the cosine of the tilt angle. Therefore, in particular lower stop forces and a more precise adaptation possibility result than in the case of a radially positioned stop sensor or stop element.

Within the scope of another specific embodiment, the drive system includes a friction brake. The friction brake may include in particular a rotatable friction element and at least one brake element which may be pressed against the friction element. For example, the friction brake may be a drum brake or a disc brake. The brake element may accordingly include a brake lining or brake pad or be a brake lining or brake pad. The brake element may be able to be pressed against the friction element by a brake shoe or a brake caliper, for example. The rotatably mounted part of the drive system may include in particular the friction element, in particular the brake drum or the brake disc. In particular the stop sensor may be able to be contacted by the friction element, in particular the brake drum or the brake disc, in the event of a bearing tilt.

The drive system may be in particular a larger drive system made of at least two electric motors, which are designed as wheel hub drives. In particular to reduce forces acting on the bearing(s) and to compensate for a bearing tilt by targeted activation of the drive system, it is advantageous if the drive system includes at least two, possibly even four, electric motors designed as wheel hub drives, in particular since the wheel speed and/or the braking torques and/or the drive torques of the wheels driven therewith may be both decreased and increased independently of one another.

Within the scope of another specific embodiment, the drive system therefore includes multiple, in particular at least two, for example, four wheel hub drives having a stationary part and a rotatably mounted part, in each case the stationary parts including the stator and the rotatably mounted part including the rotor of an electric motor.

Within the scope of another specific embodiment, the drive system includes a safety unit for processing bearing tilt data ascertained by the bearing tilt detection system.

In particular, the safety unit may be designed for the purpose, in particular if a predefined limiting value is exceeded, of initiating targeted activation of the drive system (derating, torque vectoring), to reduce the forces acting on the bearing and therefore the bearing tilt. This may be carried out, for example, by a targeted increase and/or decrease of the wheel speed and/or the braking torque and/or the drive torque of one or multiple wheels of the vehicle.

Alternatively or additionally thereto, the safety unit may also be designed for the purpose, in particular if a predefined limiting value is exceeded, of outputting a warning message, in particular to the vehicle driver, in particular to suggest an adaptation of the mode of driving and/or the performance of maintenance work.

Alternatively or additionally thereto, the safety unit may be designed for the purpose, in particular if a predefined limiting value is exceeded, of initiating an emergency running mode of the drive system, for example, having a restricted performance capability of the drive system.

Alternatively or additionally thereto, the safety unit may also be designed for the purpose of storing and/or outputting bearing tilt data, in particular to document the bearing load or bearing tilt, and/or to make a statement about the usage of the vehicle and/or the status of the system, in particular of the bearing (bearing damage), for example, the number and/or the amount of a bearing tilt exceeding a predefined limiting value.

Another object of the present invention is an electric and/or hybrid vehicle which includes a drive system according to the present invention.

Another object of the present invention is the use of
data about the inductance of stator windings of a stator, which are used as electromagnets, and/or
data about the induced counter voltage ((counter EMF) during motor operation) and/or the induced voltage ((EMF) during generator (idle) operation) in particular in stator windings of a stator used as electromagnets, and/or
data from at least one distance sensor, and/or
data from at least one stop sensor, and/or
data from a resolver, and/or
data from an ABS sensor system, and/or
data from at least one wheel speed sensor, in particular of an ABS system, and/or
data from at least one sensor, which is oriented in particular onto an encoder ring having permanent magnets, for measuring the magnetic flux density, for example, a magnetoresistive sensor, inductive sensor, or Hall sensor,
   for detecting a bearing tilt, in particular the presence and/or degree of a bearing tilt, of a bearing, in particular of an electric motor, for example, of an electric motor designed as a wheel hub drive.

In particular the bearing tilt detection may be used to initiate targeted activation (derating, torque vectoring) of a drive system, which includes in particular electric motors designed as wheel hub drives, for example, by targeted increase and/or decrease of the wheel speed and/or the braking torque and/or the drive torque of one or multiple wheels of the vehicle, for example, to compensate for a bearing tilt of one or more of the electric motors.

### BRIEF DESCRIPTION OF THE DRAWINGS

The present invention will be explained in greater detail hereafter with reference to the appended drawings. The drawings and the description thereof are to be used to illustrate the specific embodiments according to the present invention and are not to be used to restrict the present invention in any way.

FIG. 1 shows a schematic cross section through a first specific embodiment of a drive system having a stop sensor;

FIG. 2 shows a schematic cross section through a second specific embodiment of a drive system having a stop sensor;

FIG. 3a shows a schematic perspective view of a stationary part of a wheel bearing, which is equipped with two magnetoresistive sensors;

FIG. 3b shows a schematic top view of the wheel bearing shown in FIG. 3a;

FIG. 4 shows a schematic sketch to illustrate a sensor-free measurement of a bearing tilt; and

FIG. 5 shows a schematic sketch to illustrate a measurement of a bearing tilt using a resolver.

### DETAILED DESCRIPTION

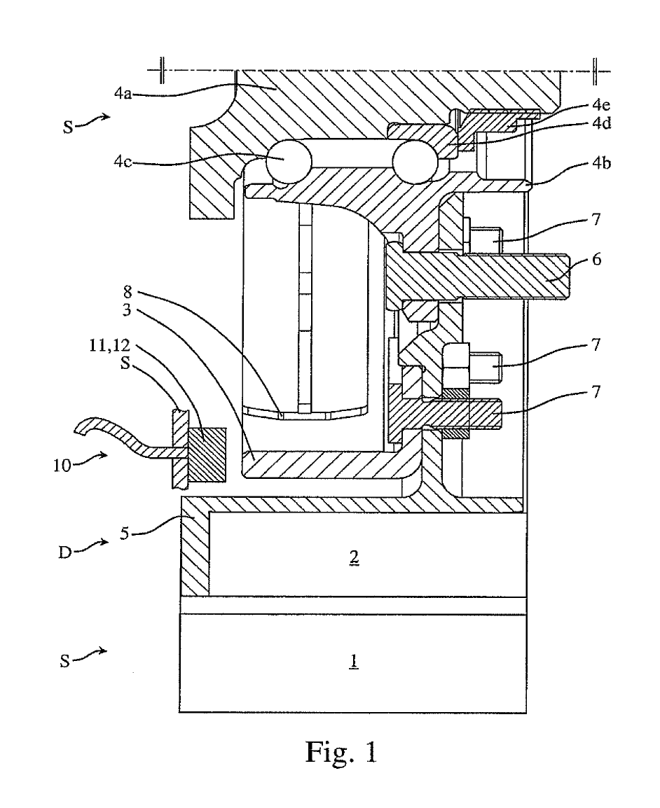

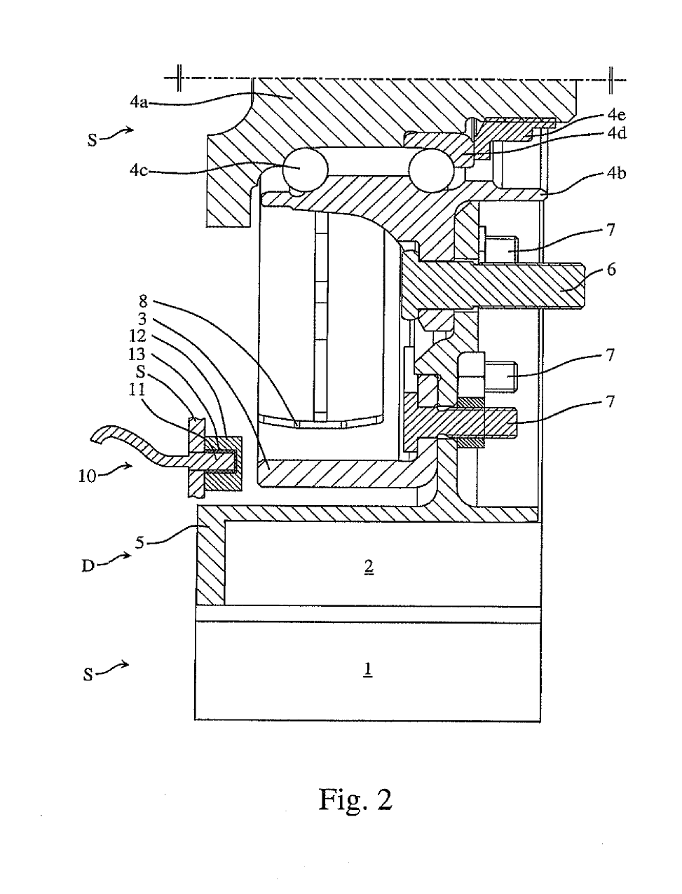

FIGS. 1 and 2 show schematic cross sections through specific embodiments of drive systems, which are equipped with a stop sensor 10. Since the drive systems are designed to be essentially rotationally symmetrical, only details of the overall cross sections are shown in the figures.

FIG. 1 shows that the drive system includes a stationary part S and a rotatably mounted part D and also an electric motor having a stator 1 and a rotor 2. Stationary part S of the drive system includes stator 1 and rotatably mounted part D of the drive system includes rotor 2. FIG. 1 illustrates that the drive system is a wheel hub drive designed as an internal-rotor electric motor.

Furthermore, FIG. 1 illustrates that rotor 2 is connected to a rotor support 5. Rotor support 5 is in turn connected via a screw connection 6 to a rotatable outer ring 4b of a wheel bearing and a wheel rim (not shown). Rotatable outer ring 4b of the wheel bearing is in turn connected via a roller bearing, which includes a roller body 4c, to stationary part 4a of the wheel bearing. Roller bodies 4c are situated in roller bearing cages (not shown), the wheel bearing being able to be braced by a bracing device 4e, which interacts with a roller bearing inner ring 4d. A brake drum 3 of a drum brake is connected to rotor support 5 by multiple screw connections 7, brake shoes 8, which may be pressed against the inner lateral surface of brake drum 3, being situated inside brake drum 3.

FIGS. 1 and 2 illustrate that stop sensor 10 is attached in each case on stationary part S of the drive system.

Within the scope of the first specific embodiment shown in FIG. 1, stop sensor 10 has an essentially block-shaped stop element 12 made of brass, which is also used as an electrical contact element 11. Stop and contact element 11, 12 is situated on stationary part S of the drive system axially spaced apart from rotatably mounted part D of the drive system. If a predetermined amount of a bearing tilt is exceeded, stop sensor 10 may be contacted by rotatably mounted part D of the drive system, in particular by brake drum 3. Since stop element 11, 12 is also used within the scope of this specific embodiment as an electrical contact element, an electrical contact, in particular a circuit, between stop and contact element 11, 12 and brake drum 3 is closed essentially simultaneously with a contact between brake drum 3 and stop and contact element 11, 12, this contact being able to be output as a signal for the presence of a strong bearing tilt.

The second specific embodiment shown within the scope of FIG. 2 essentially differs in that stop sensor 10 includes an electrical contact element 11, a stop element 12, and an insulation element 13 for the electrical insulation of electrical contact element 11 and stop element 12. FIG. 2 illustrates that therefore an electrical contact, in particular a circuit, between electrical contact element 11 and brake drum 3 may only be closed after at least partial abrasive wear of stop element 12 and insulation element 13 by one or multiple, for example, numerous contacts of brake drum 3 and stop element 12.

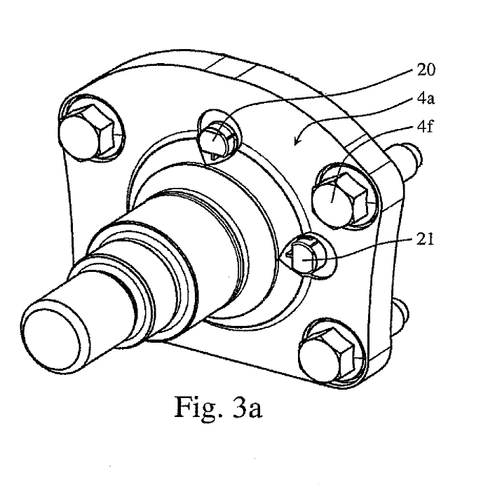

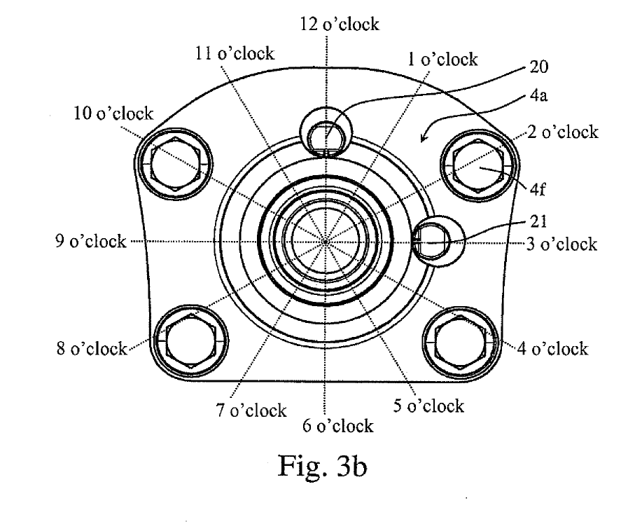

FIGS. 3a and 3b show views of a stationary part 4a of a wheel bearing. FIGS. 3a and 3b show that stationary wheel bearing part 4a has two sensors 20, 21 for measuring the magnetic flux density, which may be oriented onto an encoder ring (not shown) situated on the rotatable part of the wheel bearing, in particular to detect a bearing tilt. Sensors 20, 21 for measuring the magnetic flux density may be, for example, axially or radially reading Hall sensors or magnetoresistive sensors. Such sensors may read out the magnetic field of the encoder ring similarly to ABS sensing. One of the two sensors 20 for measuring the magnetic flux density is situated above bearing 4a, in particular in a 12 o'clock position in relation to bearing 4a. The other sensor 21 is situated essentially in the plane of bearing 4a, in particular in a 3 o'clock position in relation to the bearing. By offsetting the amplitudes of the recorded sinusoidal signals, the tilt of the wheel bearing and the components connected to wheel bearing 4a may thus advantageously be inferred.

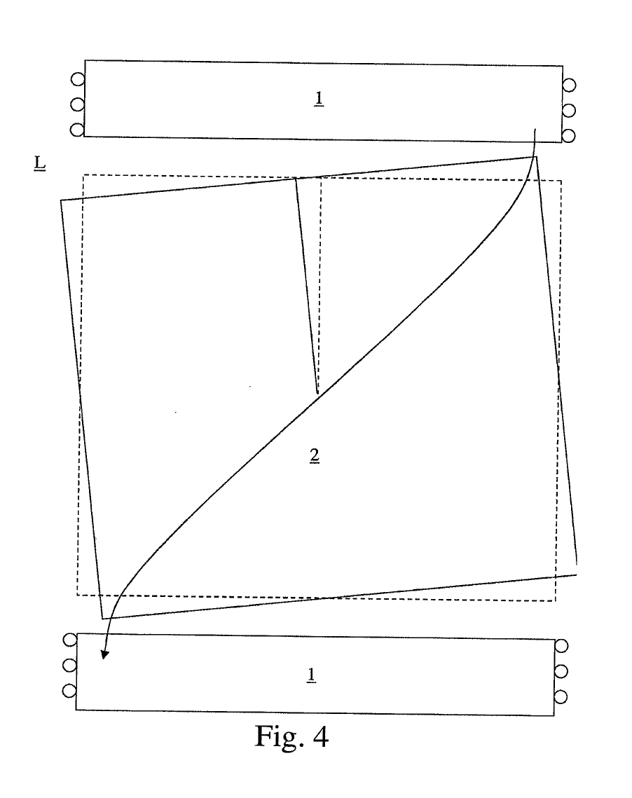

FIG. 4 shows a sketch of a sensor-free measurement of a bearing tilt of a rotor 2 with respect to a ferrous stator 1, reference sign L standing for air. The magnetic resistance between the two bodies changes due to the bearing tilt. A tilt in particular results in an increase of the inductance of the stator windings, above all perpendicularly to the tilt axis.

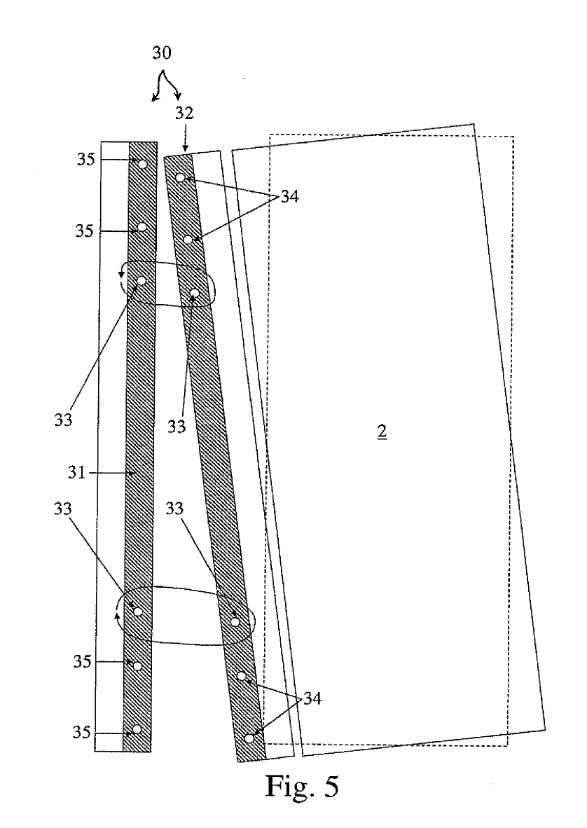

FIG. 5 shows a sketch of a measurement of a bearing tilt of a rotor 2, which is equipped with a resolver rotor 32, with respect to a resolver stator 31 of a resolver 30. FIG. 5 shows that resolver 30 has transformer windings 33, exciter windings 34, and sine windings 35. The inductance may remain unchanged in particular at the height of the tilt axis. The magnetic resistance between resolver stator 31 and resolver rotor 32 may be reduced above this, while an opposing effect results in the lower area. Since the magnetic resistance, under the assumption of very high magnetic conductivity in the area outside the two resolver circuit boards 31, 32, may be directly proportional to the length of the air gap, and the magnetic resistance of the upper and lower areas may represent a parallel circuit in particular, the reduction of the magnetic resistance in the upper area may predominate in particular. This may also apply under an assumption of a lower magnetic conductivity, the resulting relative inductance change being less in particular. This effect is measurable using multiple methods, for example, via the intrinsic inductances of the individual coils or the coupling/counter inductances thereof, for example, via a current/voltage measurement.

### LIST OF REFERENCE NUMERALS

S stationary part of the drive system
D rotatably mounted part of the drive system
1 stator
2 rotor
3 brake drum
4a stationary part of the wheel bearing
4b rotating part of the wheel bearing
4c roller body
4d roller bearing inner ring
4e roller bearing bracing
4f bearing fastening screws
5 rotor support
6 rotor support fastening screw
7 brake drum screw connection
8 brake shoe
10 stop sensor
11 electrical contact element
12 stop element
13 insulation element
20 magnetoresistive sensor in 12 o'clock position
21 magnetoresistive sensor in 3 o'clock position
L air
30 resolver
31 resolver stator
32 resolver rotor
33 transformer windings
34 exciter windings
35 sine windings

What is claimed is:

1-14. (canceled)

15. A drive system comprising:
a stationary part;
a rotatably mounted part;
an electric motor having a stator and a rotor, the stationary part including the stator and the rotatably mounted part including the rotor; and
a bearing tilt detection system for detecting a bearing tilt of the rotatably mounted part, the bearing tilt detection system analyzing data of the electric motor or at least one sensor as to whether a bearing tilt exists,
the electric motor being designed as a wheel hub drive.

16. The drive system as recited in claim 15 wherein the stator has stator windings used as electromagnets, the bearing tilt detection system for detecting a bearing tilt analyzing data about the inductance of the stator windings.

17. The drive system as recited in claim 15 wherein the bearing tilt detection system for detecting a bearing tilt analyzes data about the induced counter voltage or the induced voltage.

18. The drive system as recited in claim 15 wherein the bearing tilt detection system for detecting a bearing tilt analyzes data of at least one distance sensor.

19. The drive system as recited in claim 15 wherein the bearing tilt detection system for detecting a bearing tilt analyzes data from a stop sensor of the at least one sensor, the stop sensor having an electrical contact element situated on the stationary part, spaced apart from the rotatably mounted part, the stop sensor being contactable by the rotatably mounted part if a predetermined amount of a bearing tilt is exceeded, an electrical contact between the electrical contact element and the rotatably mounted part of the being closable if a predetermined amount of a bearing tilt is exceeded.

20. The drive system as recited in claim 19 wherein the electrical contact is part of a circuit.

21. The drive system as recited in claim 19 wherein contact of the stop sensor and the rotatable part of the drive system or the electrical contact between the electrical contact element and the rotatable part occurs in the case of a smaller amount of a bearing tilt than another contact of the stator and the rotor.

22. The drive system as recited in claim 19 wherein the stop sensor has a stop element used as the electrical contact element, or the stop sensor includes an insulation element for the electrical insulation of the electrical contact element from the stop element, the electrical contact between the electrical contact element and the rotatably mounted part being closable only after at least partial abrasive wear of the stop element and the insulation element by one or multiple contacts with the rotatably mounted part.

23. The drive system as recited in claim 22 wherein the stop element is made of brass.

24. The drive system as recited in claim 19 wherein the stop sensor is situated axially or radially with respect to the rotatably mounted part or the stop sensor is situated remotely from the bearing or adjacent to a larger diameter component of the rotatably mounted part.

25. The drive system as recited in claim 25 wherein the stop sensor is situated axially with respect to the rotatably mounted part.

26. The drive system as recited in claim 15 further comprising a friction brake, the rotatably mounted part including a friction element of the friction brake.

27. The drive system as recited in claim 26 wherein a stop sensor of the at least one sensor is contactable by the friction element in the event of a bearing tilt.

28. The drive system as recited in claim 26 wherein the friction element is a brake drum or a brake disc.

29. The drive system as recited in claim 25 wherein the bearing tilt detection system for detecting a bearing tilt analyzes data from a resolver.

30. The drive system as recited in claim 15 wherein the rotatably mounted part has an encoder ring with permanent magnets, and the stationary part has at the least one sensor oriented onto the encoder ring, for measuring magnetic flux density, the bearing tilt detection system for detecting a bearing tilt analyzing data of the at least one sensor for measuring the magnetic flux density.

31. The drive system as recited in claim 30 wherein at least one of the sensors for measuring the magnetic flux density is situated above or below the bearing.

32. The drive system as recited in claim 31 wherein the at least one sensor is in a position, in relation to the bearing, in a range between an 11 o'clock position and a 1 o'clock position or between a 5 o'clock position and a 7 o'clock position.

33. The drive system as recited in claim 30 wherein at least one of the sensors is situated at least essentially in the plane of the bearing.

34. The drive system as recited in claim 33 wherein the at least one sensor is in a position, in relation to the bearing, in a range between an 8 o'clock position and a 10 o'clock position or between a 2 o'clock position and a 4 o'clock position.

35. The drive system as recited in claim 15 wherein the system includes multiple wheel hub drives, each having one stationary part and one rotatably mounted part, in each case the stationary parts including the stator and the rotatably mounted parts including the rotor of an electric motor.

36. The drive system as recited in claim 15 further comprising a safety unit for processing bearing tilt data ascertained by the bearing tilt detection system, the safety unit for the purpose:
of storing or outputting bearing tilt data, to document the bearing load or bearing tilt, or to make a statement about the usage of the vehicle or the status of the system, or if a predefined limiting value is exceeded:
initiating a targeted activation of the drive system, to reduce the forces acting on the bearing, or outputting a warning message or initiating an emergency running mode of the drive system.

37. An electric or hybrid vehicle comprising the drive system as recited in claim 15.
